(19) United States
(12) Patent Application Publication
(10) Pub. No.: US 2014/0245860 A1
(43) Pub. Date: Sep. 4, 2014

(54) VEHICLE DRIVE APPARATUS

(71) Applicants: Hiromichi Kimura, Okazaki-shi (JP); Takeshi Kuwahara, Nisshin-shi (JP); Taturou Obata, Toyota-shi (JP); Yoshinori Morita, Toyota-shi (JP); Shingo Katou, Toyota-shi (JP); Takeshi Kitahata, Toyota-shi (JP); Takuya Kodama, Toyota-shi (JP)

(72) Inventors: Hiromichi Kimura, Okazaki-shi (JP); Takeshi Kuwahara, Nisshin-shi (JP); Taturou Obata, Toyota-shi (JP); Yoshinori Morita, Toyota-shi (JP); Shingo Katou, Toyota-shi (JP); Takeshi Kitahata, Toyota-shi (JP); Takuya Kodama, Toyota-shi (JP)

(73) Assignee: TOYOTA JIDOSHA KABUSHIKI KAISHA, Toyota-shi, Aichi (JP)

(21) Appl. No.: 14/351,488

(22) PCT Filed: Oct. 14, 2011
(86) PCT No.: PCT/JP2011/073742

§ 371 Date: Apr. 11, 2014

(51) Int. Cl. F16H 57/025

(52) U.S. Cl. CPC F16H 57/025; F16H 2057/02043
USPC 74/606 R

(57) ABSTRACT

A vehicle drive device includes: a transaxle case including a tubular case opened in at least one end portion and a cover fixed to an opening portion of the tubular case to close an opening of the tubular case, the transaxle case housing a transmission; and a mount device attached between the cover of the transaxle case and a vehicle body to support the transaxle case, the mount device including a support plate member fixedly disposed on the cover, the support plate member being fastened by at least three first fastening members through the cover to the opening portion of the tubular case.

### TECHNICAL FIELD

The present invention relates to a vehicle drive device including a transaxle case and a mount device supporting the transaxle case and particularly to a technique of attaching the mount device to a cover of the transaxle case.

### BACKGROUND ART

For example, as described in Patent Document 1, a vehicle drive device may include (a) a transaxle case that houses a transmission and has a tubular case having a predetermined width dimension and opened in at least one end portion in a width direction and a cover fixed to an opening portion of the tubular case to close an opening of the tubular case, and a mount device that is attached between the transaxle case and a vehicle body to support the transaxle case. In Patent Document 1, the mount device is attached between an upper portion of the tubular case in the transaxle case and a portion of the vehicle body, i.e., a front side member.

### PRIOR ART DOCUMENT

### Patent Document

Patent Document 1: Japanese Laid-Open Patent Publication No. 09-309344

### SUMMARY OF THE INVENTION

### Problem to Be Solved by the Invention

In the vehicle drive device as described above, a conventional mount device is set such that a mount fastening portion of the mount device is located on the upper portion of the tubular case as described in Patent Document 1. However, since the height of the transaxle case is relatively high, the mount fastening portion may be located at a position higher than the front side member. In such a case, even if it is attempted to use the conventional mount device for attaching the mount device to the upper portion of the tubular case of the transaxle case, the mount device interferes with the cover of the transaxle case, making it difficult to attach the mount device to the tubular case of the transaxle case by using the conventional mount device. Therefore, in the above case, the mount fastening portion of the conventional mount device is fixed to the cover to attach the conventional mount device between the cover and the front side member.

However, in the vehicle drive device having the mount device attached between the cover and the front side member as described above, the cover of the transaxle case has lower rigidity as compared to the tubular case of the transaxle case and, therefore, the rigidity of the cover must be enhanced as compared to a conventional cover for supporting a load of the transaxle case by forming a rib on the cover or by increasing a thickness of the cover.

The present invention was conceived in view of the situations and it is therefore an object of the present invention to provide a vehicle drive device preferably supporting a transaxle case by a mount device attached to a cover without enhancing the rigidity of the cover as compared to a conventional cover.

### Means for Solving the Problem

To achieve the object, the present invention provides a vehicle drive device (a) comprising: a transaxle case including a tubular case opened in at least one end portion and a cover fixed to an opening portion of the tubular case to close an opening of the tubular case, the transaxle case housing a transmission; and a mount device attached between the cover of the transaxle case and a vehicle body to support the transaxle case, (b) the mount device including a support plate member fixedly disposed on the cover, (c) the support plate member being fastened by at least three first fastening members through the cover to the opening portion of the tubular case.

### EFFECTS OF THE INVENTION

According to the vehicle drive device of this invention, (b) the mount device includes the support plate member fixedly disposed on the cover and (c) the support plate member is fastened by the at least three first fastening members to the opening portion of the tubular case through the cover. Therefore, since a load of the transaxle case acts through the first fastening member on the opening portion of the tubular case having the rigidity higher than the cover, the transaxle case is preferably supported by the mount device attached to the cover without enhancing the rigidity of the cover as compared to a conventional cover.

Preferably, the support plate member is fastened to the cover by a second fastening member within a polygonal region having the at least three first fastening members as respective vertexes. As a result, since the cover has the support plate member fastened to the cover, the rigidity of the cover is preferably improved.

### BRIEF DESCRIPTION OF THE DRAWINGS

FIG. 1 is a plane view of a general configuration of a transaxle (vehicle drive device) to which the present invention is applied.

FIG. 2 is a side view seen along a direction of an arrow II of FIG. 1, and in this drawing, a front side member etc. to which a mount device is attached is omitted, for explaining the support plate member of the mount device attached to the cover of the transaxle of FIG. 1.

FIG. 3 is a cross-section view taken from a line of FIG. 2 illustrating a state in which the support plate member of FIG. 2 is fastened to the opening portion of the tubular case, to which the cover is fixed, by three first bolts (first fastening members) through the cover.

FIG. 4 is a cross-section view taken from a line IV-IV of FIG. 2 illustrating a state in which the support plate member of FIG. 2 is fastened to the cover in a close contact manner by two second bolts (second fastening members).

### MODE FOR CARRYING OUT THE INVENTION

An embodiment of the present invention will now be described in detail with reference to the drawings. In the following embodiment, the figures are simplified or deformed as needed to facilitate understanding and portions are not necessarily precisely depicted in terms of dimension ratio, shape, etc.

### First Embodiment

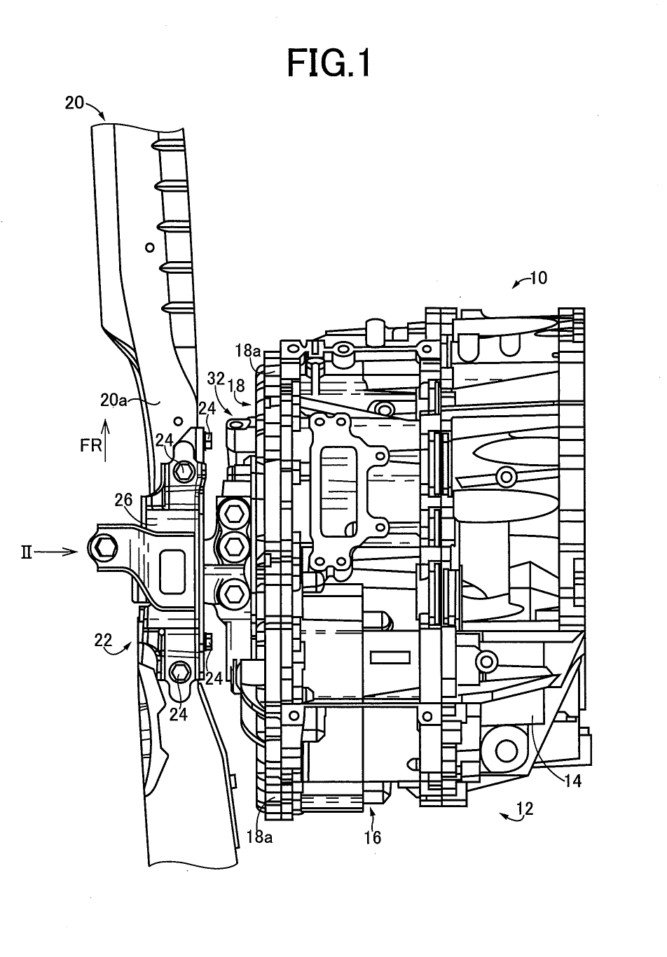

FIG. 1 is a plane view of a general configuration of a transaxle (vehicle drive device) 10 of an embodiment of the present invention. In FIG. 1, an arrow FR indicates a vehicle forward direction. The transaxle 10 is a transaxle for a two-motor hybrid automobile, for example. As depicted in FIG. 1, the transaxle 10 includes a transaxle case 12 housing a known electric continuously variable transmission (transmission) incorporating a first electric motor and a second electric motor, and a differential gear device, etc.

As depicted in FIG. 1, the transaxle case 12 has a housing 14 adjacent to an engine not depicted, a tubular case 16 having a predetermined width dimension and opened in both end portions in a width direction, and a cover 18 fixed to an opening portion 16a of the tubular case 16 so as to close an opening of an end portion of the tubular case 16 further from the housing 14, which are integrally fixed by bolts not depicted. The width direction of the tubular case 16 is a vehicle width direction orthogonal to the arrow FR of FIG. 1.

As depicted in FIG. 1, the transaxle 10 includes a mount device 22 attached between the cover 18 of the transaxle case 12 and a front side member 20a located on the left side of the vehicle depicted in FIG. 1 in a vehicle body frame (vehicle body) 20 so as to support the transaxle case 12, i.e., the transaxle 10. Although not depicted, another pair of respective mount devices is attached to the transaxle 10 on the vehicle forward side of the housing 14 and the vehicle backward side of the housing 14.

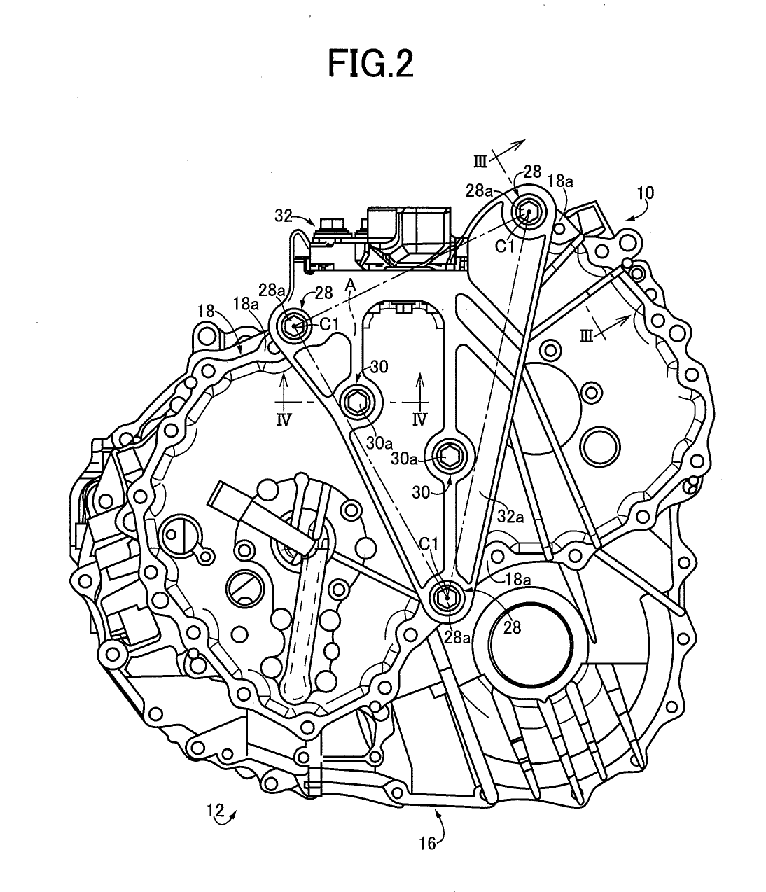

As depicted in FIG. 1, the mount device 22 includes a vehicle body frame side member 26 integrally fastened to the front side member 20a by a plurality of bolts 24, a transaxle side member 32 fastened to the cover 18 of the transaxle case 12 by a plurality of, or in this embodiment, five bolts, i.e., three first bolts (first fastening members) 28 and two second bolts (second fastening members) 30 depicted in FIG. 2, and a cylindrical-shaped mount bush not depicted made of an elastic member such as rubber interposed between the transaxle side member 32 and the vehicle body frame side member 26. Vibration generated in the transaxle 10 is absorbed or attenuated by the mount bush.

As depicted in FIG. 2, the transaxle side member 32 integrally includes a plate-shaped support plate member 32a fixedly disposed on the cover 18 of the transaxle case 12 by fastening the first bolts 28 and the second bolts 30. An outer circumferential edge portion 18a of the cover 18 is fixed to the opening portion 16a of the tubular case 16 in an overlapping manner, and the support plate member 32a causes the cover 18 to be fastened to the tubular case 16 by screwing the three first bolts 28 into the opening portion 16a of the tubular case 16 through the outer circumferential edge portion 18a of the cover 18.

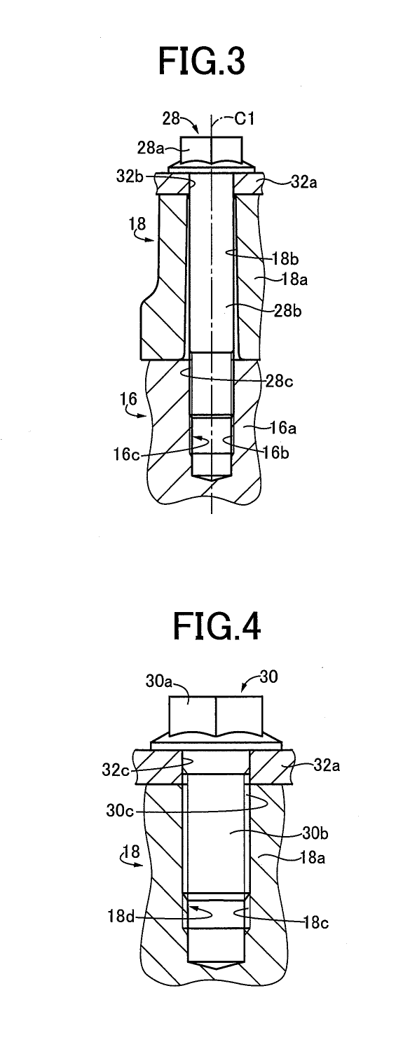

As depicted in FIGS. 2 and 3, each of the three first bolts 28 includes a column-shaped shaft portion 28b projected from a head portion 28a and a male screw portion 28c threaded on an outer circumference of a leading end portion of the shaft portion 28b. Penetrating first insertion holes 32b and 18b having a circular cross section are formed at three positions in the support plate member 32a and the outer circumferential edge portion 18a of the cover 18, respectively, for allowing insertion of the leading end portions of the shaft portions 28b of the first bolts 28. As depicted in FIG. 3, the opening portion 16a of the tubular case 16 is provided with a female screw hole 16c having a female screw portion 16b screwed with the male screw portion 28c of the leading end portion of the first bolt 28 inserted through the first insertion holes 32b and 18b. Each of the three first bolts 28 has the leading end portion inserted though the first insertion hole 32b of the support plate member 32a and the first insertion hole 18b of the outer circumferential edge portion 18a of the cover 18 and has the male screw portion 28c screwed into the female screw portion 16b of the opening portion 16a of the tubular case 16 and, as a result, the support plate member 32a is fastened to the opening portion 16a of the tubular case 16 via the outer circumferential edge portion 18a of the cover 18.

As depicted in FIG. 2, the support plate member 32a is fastened in close contact with the cover 18 by the two second bolts 30 in a triangular region A having axial centers C1 of the three first bolts 28 as the respective vertexes.

As depicted in FIGS. 2 and 4, each of the two second bolts 30 includes a column-shaped shaft portion 30b projected from a head portion 30a and a male screw portion 30c threaded on an outer circumference of the shaft portion 30b. Penetrating second insertion hole 32c having a circular cross section is formed at two positions in the triangular region A of the support plate member 32a, for allowing insertion of leading end portions of the shaft portions 30b of the second bolts 30. As depicted in FIG. 4, the triangular region A of the cover 18 is provided with a female screw hole 18d having a female screw portion 18c screwed with the male screw portion 30c of the leading end portion of the second bolt 30 inserted through the second insertion hole 32c. Each of the two second bolts 30 has the leading end portion inserted though the second insertion hole 32c of the support plate member 32a and has the male screw portion 30c screwed into the female screw portion 18c of the female screw hole 18d of the cover 18 and, as a result, the support plate member 32a is fastened in close contact with the cover 18.

According to the transaxle 10 of this embodiment, the mount device 22 includes the support plate member 32a fixedly disposed on the cover 18 and the support plate member 32a is fastened by the three first bolts 28 to the opening portion 16a of the tubular case 16 through the outer circumferential edge portion 18a of the cover 18. Therefore, since a load of the transaxle case 12 acts through the three first bolts 28 on the opening portion 16a of the tubular case 16 having the rigidity higher than the cover 18, the transaxle case 12, i.e., the transaxle 10 is preferably supported by the mount device 22 attached to the cover 18 without enhancing the rigidity of the cover 18 as compared to a conventional cover.

According to the transaxle 10 of this embodiment, since the rigidity of the cover 18 is not enhanced as compared to a conventional cover and, for example, it is not necessary to form a rib on the cover 18 or increase a thickness of the cover 18, a space between the cover 18 and the front side member 20a is preferably made larger and the mountability of the transaxle 10 attached to the vehicle body frame 20 is improved.

According to the transaxle 10 of this embodiment, the support plate member 32a is fastened in close contact with the cover 18 by the two second bolts 30 in the triangular region A having the axial centers C1 of the three first bolts 28 as the respective vertexes. As a result, since the cover 18 has the support plate member 32a fastened in close contact with the cover 18, the rigidity of the cover 18 is preferably improved.

According to the transaxle 10 of this embodiment, since the support plate member 32a is fastened in close contact with the cover 18 and the rigidity of the cover 18 is improved, a membrane oscillation of the cover 18 is preferably suppressed.

Although the embodiment of the present invention has been described with reference to the drawings, the present invention is applied in other forms.

For example, with regard to the transaxle 10 of this embodiment, although the transaxle for a two-motor hybrid automobile is used for the transaxle 10, the transaxle 10 of this embodiment is not limited to the transaxle for a two-motor hybrid automobile and is applied to various transaxles based on the knowledge of those skilled in the art.

In the transaxle 10 of this embodiment, the tubular case 16 is formed to open in the both ends of the tubular case 16. However, the shape of the tubular case 16 may open in the end portion to which the cover 18 of the tubular case 16 is fixed, and may be closed in the end portion opposite to the end portion to which the cover 18 of the tubular case 16 is fixed.

In the transaxle 10 of this embodiment, the support plate member 32a is fastened by the three first bolts 28 through the outer circumferential edge portion 18a of the cover 18 to the opening portion 16a of the tubular case 16. However, the support plate member 32a is not limited to that fastened by the three first bolts 28 in this embodiment and may be fastened by the at least three, i.e., three or more, first bolts 28. If the three or more first bolts 28 are used, a polygonal region A is formed that has the axial centers C1 of the first bolts 28 as the respective vertexes. Therefore, the support plate member 32a must be fastened to the cover 18 by the second bolts 30 within the polygonal region A. Although the two second bolts 30 are used in this embodiment, the number of the second bolts 30 is not limited given that the second bolts 30 are disposed within the region A.

Although not exemplarily illustrated one by one, the present invention may be implemented in variously modified and improved forms based on the knowledge of those skilled in the art.

### NOMENCLATURE OF ELEMENTS

10: transaxle (vehicle drive device)
12: transaxle case
16: tubular case
16a: opening portion
18: cover
20: vehicle body frame (vehicle body)
22: mount device
28: first bolt (first fastening member)
30: second bolt (second fastening member)
32a: support plate member
A: region

1. A vehicle drive device comprising: a transaxle case including a tubular case opened in at least one end portion and a cover fixed to an opening portion of the tubular case to close an opening of the tubular case, the transaxle case housing a transmission; and a mount device attached between the cover of the transaxle case and a vehicle body to support the transaxle case,
the mount device including a support plate member fixedly disposed on the cover,
the support plate member being fastened by at least three first fastening members through the cover to the opening portion of the tubular case.

2. The vehicle drive device of claim 1, wherein the support plate member is fastened to the cover by a second fastening member within a polygonal region having the at least three first fastening members as respective vertexes.
